(19) United States
(12) Patent Application Publication
(10) Pub. No.: US 2007/0074864 A1
(43) Pub. Date: Apr. 5, 2007

(54) Water-cooled constant temperature liquid circulating device and method of controlling temperature of circulating liquid with the same

(75) Inventors: Takeo Ichinose, Tsukubamirai-shi (JP); Katsutoshi Sato, Tsukubamirai-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SMC Corporation, Chiyoda-ku (JP)

(21) Appl. No.: 11/521,475

(22) Filed: Sep. 15, 2006

(30) Foreign Application Priority Data
Sep. 30, 2005 (JP) 2005-288602

(51) Int. Cl. F24F 11/04; G05D 23/00

(52) U.S. Cl. 165/247; 165/293

(57) ABSTRACT

To provide a water-cooled constant temperature liquid circulating device in which the stability in temperature of circulating liquid can be improved by optimizing a flow channel of radiating water and a method of controlling the temperature of circulating liquid in the same device. In a water-cooled constant temperature liquid circulating device in which a heat exchange portion of the radiator tube, in which radiating water which is controlled in flow amount flows therein, is attached to a tank, a pump is provided in a conduit which allows the circulating liquid in the tank to circulate through the external device, and constant temperature circulating liquid is delivered into the piping in the external device by the pump, comprising: an electric proportional valve for controlling the flow amount of radiating water to be delivered to the heat exchange portion of the radiator tube and an electromagnetic valve for delivering the radiating water, which is controlled in flow amount by the electric proportional valve, to the heat exchange portion in an optimal flow amount regulated by controlling the opening-closing duration thereof. The electric proportional valve is controlled to a flow amount suitable for heat exchange with respect to circulating liquid at the heat exchange portion and equal to, or larger than, a low flow limit value that can be controlled by the electric proportional valve, or to an amount slightly larger than that value.

### TECHNICAL FIELD

The present invention relates to a water-cooled constant temperature liquid circulating device and a method of controlling the temperature of circulating liquid with the same.

### BACKGROUND ART

Hitherto, a device as shown in FIG. 3 is known as a water-cooled constant temperature liquid circulating device. The constant temperature liquid circulating device 40 includes a heat exchanger 42, the heat exchanger being composed by disposing a heat exchange portion 43a of a radiator tube 43, which allows radiating water controlled in flow amount by a regulating valve 44 to flow therein, in a tank 41 that contains circulating liquid to be controlled in temperature therein, a pump 46 provided in the conduit 45 for allowing the constant temperature liquid in the tank 41 to circulate through the external device 50, so that the constant temperature circulating liquid in the tank 41 is delivered to a piping 51 in the external device 50 with the pump 46. Then, a temperature sensor 47 for detecting the temperature (T₁) of the circulating liquid to be delivered from the constant temperature liquid circulating device 40 is provided in the vicinity of an outlet port 45a of the conduit 45, and opening/closing of the regulating valve 44 is controlled by a controller 48, so that the circulating liquid to be detected by the temperature sensor 47 is controlled to be a predetermined temperature.

As the regulating valve 44 in the radiator tube 43, a electromagnetic valve whose opening and closing frequency can be adjusted, or a proportional valve whose valve travel can be adjusted is used independently, and the temperature of the delivered circulating liquid is adjusted to a predetermined temperature under the control of these valves.

In the water-cooled constant temperature liquid circulating device 40 in the related art, since heat exchange is performed directly between radiating water and circulating water in the heat exchange portion 43a of the heat exchanger 42, when the temperature difference between radiating water and circulating liquid is significant, the cooling capability is increased. Therefore, in order to achieve the stability in temperature of circulating liquid, it is necessary to control the regulating valve 44 to flow radiating water at low flow amount. When the difference in pressure of radiating water between an inlet port and an outlet port of the radiator tube 43 is significant, it is also necessary to control radiating water to be flowed at a stable flow amount.

However, in order to lower the flow amount of radiating water when an electromagnetic valve is used as the regulating valve 44 of the radiator tube 43, it is necessary to open and close the electromagnetic valve at short intervals at a high frequency. Consequently, since the electromagnetic valve is operated under a heavy condition, shortening of the lifetime thereof cannot be avoided. On the other hand, when the flow amount of radiating water is increased by the electromagnetic valve, water hammering occurs in association with closing of the valve. Therefore, a countermeasure for this water hammering is also required.

When a proportional valve is used as the regulating valve 44 of the radiator tube 43, since control in flow amount is difficult when the valve travel is small (several percent since it is started to be opened) as a characteristic of the proportional valve itself, the flow amount must be reduced to a minimum controllable amount for achieving the small flow amount, and hence the temperature of the circulating liquid is excessively lowered. In order to restore the excessively lowered temperature of the circulating liquid, an internal heater must be provided in the heat exchanger 42, which results not only in requirement of excessive energy, but also in increase in variations in temperature of circulating liquid.

### DISCLOSURE OF THE INVENTION

A technical subject of the present invention is to provide a water-cooled constant temperature liquid circulating device in which stability in temperature of the circulating liquid in the constant temperature liquid circulating device is improved and a method of controlling the temperature of circulating liquid with the same.

Another technical subject of the present invention is to provide a water-cooled constant temperature liquid circulating device in which stability in temperature of circulating liquid can be improved under any conditions by optimizing a flow channel of radiating water and a method of controlling the temperature of circulating liquid with the same.

Still another technical subject of the present invention is to provide a water-cooled constant temperature liquid circulating device in which energy saving is achieved, and which contributes to increase in life time of the electromagnetic valve, and achieves alleviation of water hammering and a method of controlling the temperature in circulating liquid with the same.

In order to solve the above-described subjects, the present invention provides a water-cooled constant temperature liquid circulating device in which a heat exchange portion of a radiator tube, in which radiating water which is controlled in flow amount by a regulating means flows therein, is attached to a tank, a pump is provided in a conduit which allows the circulating liquid in the tank to circulate through the external device, and constant temperature circulating liquid in the tank is delivered into the piping in the external device which is connected to the inlet and outlet ports of the conduit by the pump, including: an electric proportional valve for controlling the regulating means to a flow amount which is suitable for heat exchange between the heat exchange portion and the circulating liquid at least a low flow limit value at which the flow amount of radiating water to be delivered to the heat exchange portion of the radiator tube can be controlled by the electric proportional valve, or a flow amount which is slightly larger; and an electromagnetic valve for delivering the radiating water, which is controlled in flow amount by the electric proportional valve, to the heat exchange portion in an optimal flow amount regulated by controlling the opening-closing duration thereof.

In a preferred embodiment of the water-cooled constant temperature liquid circulating device according to the present invention, a temperature sensor for detecting the temperature (T₁) of the delivered circulating liquid is provided on an outlet port side of the conduit of the constant temperature liquid circulating device, a temperature sensor for detecting the temperature (T₂) of radiating water is provided at an inlet port side of the radiator tube, pressure sensors for detecting the pressures (P₁, P₂) are provided on the inlet port side and the outlet port side of the radiator tube, and the electric proportional valve and the electromagnetic valve are controlled by a controller, which receives outputs from these sensors together with outputs from the flow amount sensor in the conduit, so as to adjust the circulating liquid to a predetermined temperature.

According to the preferred embodiment of arrangement of the electric proportional valve and the electromagnetic valve in the water-cooled constant temperature liquid circulating device in the present invention, by providing the electric proportional valve and the electromagnetic valve in the radiator tube from the upstream side toward the downstream side in series, the flow amount of the radiating water controlled in flow amount by the electric proportional valve is readjusted by the electromagnetic valve. Alternatively, by providing a bypass flow channel between the inlet port side and the outlet port side of the radiator tube, providing the electromagnetic valve in the bypass flow channel, and providing the electromagnetic valve on the downstream side of the branch point of the radiator tube with respect to the bypass flow channel, thereby controlling the flow amount to be flowed into the bypass flow channel by the electric proportional valve, the flow amount of radiating water flowing toward the electromagnetic valve is readjusted by the electromagnetic valve so that an optimal flow amount is delivered to the heat exchange portion.

According to the preferred embodiment of control by the controller in the present invention, a heat load of the external device is obtained on the basis of the difference between the temperature (T₁) of circulating liquid detected by the temperature sensor and the temperature (T₂) of radiating water and the flow amount of the circulating liquid detected by the flow amount sensor, the controller obtains a current cooling capability of the constant temperature liquid circulating device on the basis of the difference between the pressures (P₁, P₂) detected by the pressure sensors provided on the inlet port side and the outlet port side of the radiator tube and the temperature (T₂) detected by the temperature sensor provided on the inlet port side of the radiator tube, whereby the flow amount of the radiating water according to the cooling capability corresponding to the heat load is calculated and the electric proportional valve and the electromagnetic valve are controlled.

A method of controlling the temperature of circulating liquid with the water-cooled constant temperature liquid circulating device having the electric proportional valve and the electromagnetic valve arranged in series in order to solve the above-described problems according to the present invention includes: at least when the required flow amount of radiating water is smaller than the low flow limit value, controlling the electric proportional valve to flow radiating water by a low flow amount which does not underrun the low flow limit value and regulating the flow amount of the radiating water to an optimal amount by controlling the opening and closing duration of the electromagnetic valve by a controller, while when the required flow amount of radiating water exceeds a high flow limit amount which is high to an extent that may cause a water hammering phenomenon by the opening and closing the electromagnetic valve, fully opening the electromagnetic valve constantly by the controller, and controlling the flow amount of the radiating water only by the electric proportional valve.

A method of controlling the temperature of circulating liquid in the water-cooled constant temperature liquid circulating device having the electric proportional valve and the electromagnetic valve arranged in parallel according to the present invention includes: at least when the required flow amount of radiating water is smaller than the low flow limit value, lowering the pressure at an inlet port of the electromagnetic valve by opening the electric proportional valve to increase the amount of radiating water flowing in the bypass flow channel and controlling the flow amount of the radiating water to an optimal flow amount by controlling the opening and closing duration of the electromagnetic valve, while when the amount of required flow amount of radiating water exceeds a high flow limit amount which is high to an extent that may cause a water hammering phenomenon by the opening and closing the electromagnetic valve, fully opening the electromagnetic valve constantly by the controller, and controlling the flow amount of the radiating water flowing in the electromagnetic valve by controlling the valve travel of the electric proportional valve.

According to the water-cooled constant temperature liquid circulating device having the configuration described above, since the flow amount of the radiating water is controlled by the electric proportional valve by fully opening the electromagnetic valve, or by opening the electric proportional valve by a small amount of valve travel, thereby opening and closing the electromagnetic valve in a state in which the pressure and the flow amount at the inlet port of the electromagnetic valve is lowered, occurrence of the water hammering in association with the opening and closing of the electromagnetic valve can be restrained or alleviated.

Although the electric proportional valve has a characteristic such that control in flow amount is difficult when the valve travel is small (several percent since it is started to be opened), since the control of the small flow amount is performed by the electromagnetic valve, the required flow amount of radiating water is optimized, and hence the stability in temperature of the circulating liquid is improved.

According to the water-cooled constant temperature liquid circulating device and the method of controlling the temperature of circulating liquid with the same, the stability in temperature of circulating liquid in the constant temperature liquid circulating device can be improved and, in addition, by optimizing the flow channel of radiating water, the stability in temperature of circulating liquid can be improved under any conditions. Simultaneously, energy saving is achieved, the lifetime of the electromagnetic valve is improved, and the water hammering is alleviated.

### BRIEF DESCRIPTION OF THE DRAWINGS

FIG. 1 is a block diagram of a first embodiment of a water-cooled constant temperature liquid circulating device according to the present invention.

FIG. 2 is a block diagram of a second embodiment of the water-cooled constant temperature liquid circulating device according to the present invention.

FIG. 3 is a block diagram of the water-cooled constant temperature liquid circulating device in the related art.

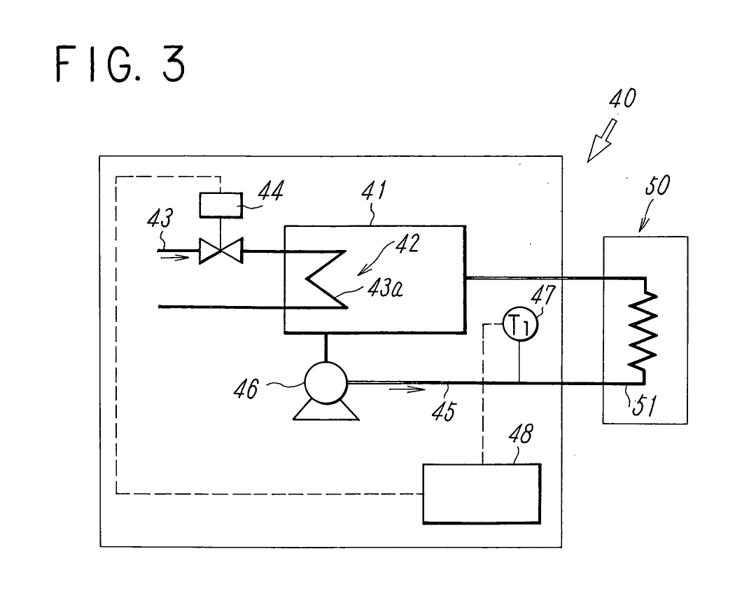

### BEST MODE FOR CARRYING OUT THE INVENTION

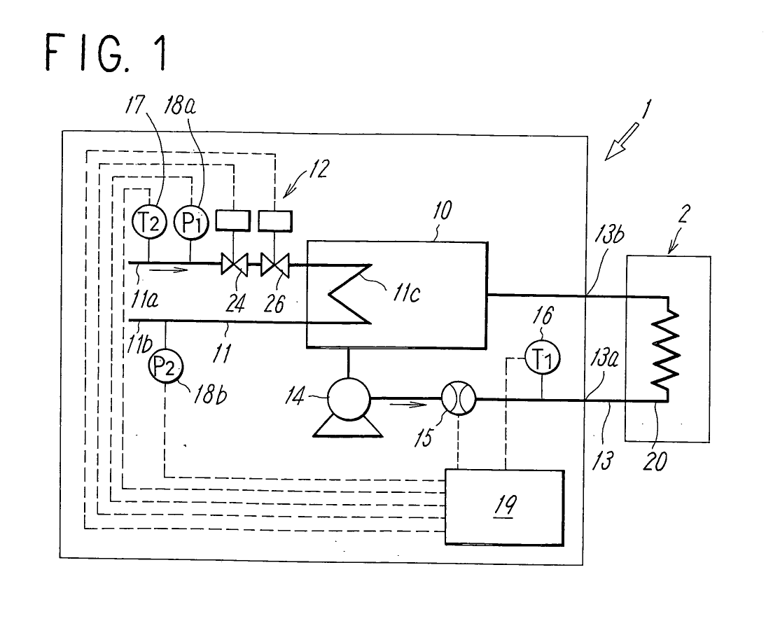

FIG. 1 shows a first embodiment of a water-cooled constant temperature liquid circulating device according to the present invention.

A basic configuration of a water-cooled constant temperature liquid circulating device 1 is such that a heat exchange portion 11c of a radiator tube 11 in which radiating water controlled in flow amount by a regulating means 12 flows is disposed, a pump 14 and a flow amount sensor 15 are provided in a conduit 13 for allowing circulating liquid in a tank 10 through an external device 2, and constant temperature circulating liquid in the tank 10 is delivered to a piping 20 of the external device 2 connected to an outlet port 13a and an inlet port 13b of the conduit 13.

The heat exchange portion 11c does not have to be necessarily in the tank 10, and heat exchange may be performed from the outside of the tank 10.

In the constant temperature liquid circulating device 1, a temperature sensor 16 for detecting the temperature (T₁) of circulating liquid delivered from the constant temperature liquid circulating device 1 is provided in the vicinity of the outlet port 13a of the conduit 13, a temperature sensor 17 for detecting the temperature (T₂) of radiating water to be flowed in the radiator tube 11 is provided on an inlet port 11a side of the radiator tube 11, and pressure sensors 18a, 18b are provided at the inlet port 11a and an outlet port 11b for detecting the pressures (P₁, P₂) thereof, so that outputs therefrom are entered to a controller 19 together with the output of the flow amount sensor 15.

The regulating means 12 for controlling the flow amount of the radiator tube 11 for allowing radiating water to flow therein controls the flow amount of radiating water so that circulating liquid detected by the temperature sensor 16 becomes a predetermined temperature and is configured by arranging an electric proportional valve 24 and an electromagnetic valve 26 in the radiator tube 11 in series from the upstream side to the downstream side thereof. The electric proportional valve 24 controls the flow amount of radiating water to be delivered to the heat exchange portion 11c of the radiator tube 11 to a flow amount suitable for heat exchange with respect to circulating liquid at the heat exchange portion 11c and equal to, or larger than, a low flow limit value that can be controlled by the electric proportional valve 24, or to an amount slightly larger than that value. The electromagnetic valve 26 delivers the radiating water controlled in flow amount by the electric proportional valve 24 to the heat exchange portion 11c as an optimal flow amount by controlling opening and closing durations thereof.

In other words, the flow amount of radiating water controlled in flow amount by the electric proportional valve 24 is readjusted by the electromagnetic valve 26, and is delivered to the heat exchange portion 11c in an optimal flow amount. Then, the electric proportional valve 24 and the electromagnetic valve 26 are controlled by the controller 19 on the basis of the outputs from the respective sensors, as described below.

The low flow limit value which can be controlled by the electric proportional valve 24 means a flow amount as shown below. In general, since the characteristics of the proportional valve itself can hardly control the flow amount within the range from the beginning to a small valve travel such as several percent, it is effective for improving the stability in temperature of circulating liquid not to control the small flow amount within such a range, and flow the minimum flow value within a range in which the flow amount can be controlled easily or a flow amount which is slightly larger than that value, and then readjust this flow amount to an optimal flow amount by the electromagnetic valve 26. The controllable low flow limit value means this minimum flow value. However, the minimum flow value is not necessarily a constant value depending on the specifications of the proportional valve, and hence an adequate flow value should be employed according to the specifications of the proportional valve.

Subsequently, a mode of control of the regulating means 12 by the controller 19 will be described. In the controller 19, a heat load of the external device 2 is obtained by calculation on the basis of the temperature difference between the temperature T₁ of circulating liquid and the temperature T₂ of radiating water detected by the temperature sensors 16, 17 and the flow amount of circulating liquid detected by the flow amount sensor 15, and the cooling capability corresponding to the heat load is calculated.

Then, the current cooling capability of the constant temperature liquid circulating device 1 is calculated by the controller 19 on the basis of the difference between the pressures P₁ and P₂ detected by the pressure sensors 18a, 18b provided on the inlet port 11a side and the outlet port 11b side of the radiator tube 11, and the temperature T₂ detected by the temperature sensor 17 provided on the inlet port 11a side of the radiator tube 11, then the flow amount of radiating water according to the cooling capability corresponding to the heat load of the external device 2 is obtained by calculation, whereby the electric proportional valve 24 and the electromagnetic valve 26 are controlled on the basis of the result thereof.

More specifically, at least when the required flow amount of radiating water is smaller than the low flow limit value, the controller 19 controls the electric proportional valve 24 to flow a low flow amount which does not underrun the limited value, thereby lowering the supplied flow amount of radiating water to the electromagnetic valve 26 by lowering the pressure at the inlet port of the electromagnetic valve 26 and then controlling the opening and closing duration of the electromagnetic valve 26, so that the flow amount of radiating water is optimally controlled. Accordingly, it is not necessary to perform opening and closing to the electromagnetic valve 26 in short intervals at high frequency any longer, and hence shortening of the lifetime of the electromagnetic valve 26 can be avoided.

In this manner, when flowing radiating water of a flow amount within the range in which the valve travel is reduced by being controlled only by the electric proportional valve 24, and hence the flow amount of radiating water can hardly be controlled, that is, of a flow amount equal to or lower than the low flow limit value of the range in which the electric proportional valve 24 can control the flow amount, the electric proportional valve 24 is controlled to flow radiating water by a flow amount not to underrun the limit value, and the control of the flow amount is performed on the initiative of the electromagnetic valve.

Even when the required flow amount of radiating water calculated by the controller 19 is equal to or higher than the low flow limit value, it is also possible to control the electric proportional valve 24 to a required flow amount of radiating water or a flow amount which is slightly larger than that and equal to or higher than the low flow limit value and then control the opening and closing duration of the electromagnetic valve 26 so as to control the flow amount of the radiating water to an optimal value. In this case, the flow amount or the pressure outputted by the electric proportional valve 24 must be in a range in which the water hammering phenomenon does not occur when the electromagnetic valve 26 is opened or closed.

On the other hand, when the required flow amount of radiating water calculated by the controller 19 exceeds the high flow limit value which is high to an extent at which the water hammering phenomenon may occur when the electromagnetic valve 26 is opened or closed, the controller 19 controls to fully open the electromagnetic valve 26 constantly, and the flow amount of radiating water is controlled only by the electric proportional valve 24. If the flow amount of radiating water is significant, the water hammering phenomenon occurs when the valve is closed when the flow amount is controlled by opening and closing the electromagnetic valve 26. However, by the control in the initiative of the electric proportional valve described above in this range, occurrence of the water hammering can be restricted.

The high flow limit value is not necessarily a constant value depending on the specifications of the radiator tube 11 which allows flowing of radiating water therein, and hence an adequate predetermined value should be employed according to the specifications or the like of the proportional valve.

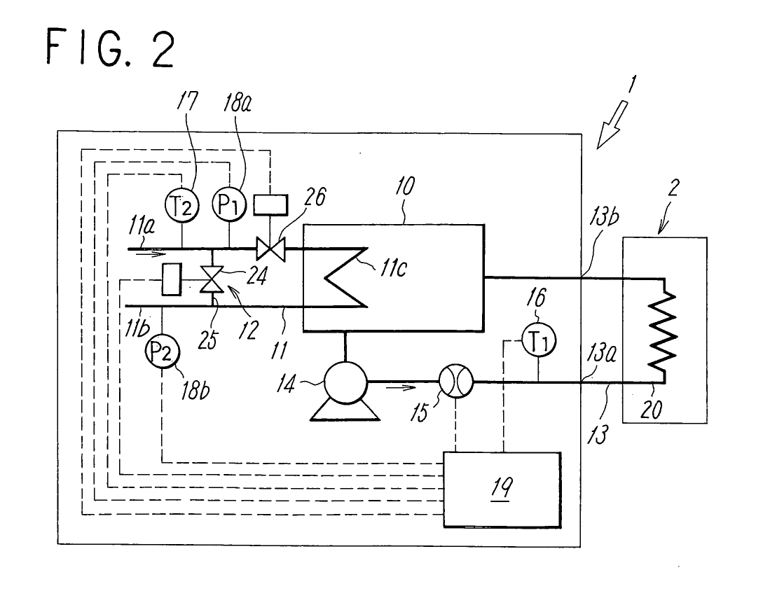

Referring now to FIG. 2, a second embodiment of the water-cooled constant temperature liquid circulating device according to the present invention will be described.

A basic configuration of the water-cooled constant temperature liquid circulating device 1 in the second embodiment is substantially the same as that in the first embodiment, and hence the corresponding parts are designated by the same reference numerals. A principle difference between the second embodiment and the first embodiment is that the electric proportional valve 24 and the electromagnetic valve 26 are arranged in the radiator tube in series as the regulating means 12 in the first embodiment, while the regulating means 12 in the second embodiment is such that a bypass flow channel 25 is provided between the inlet port 11a side and the outlet port 11b side of the radiator tube 11 and the electric proportional valve 24 and the electromagnetic valve 26 are arranged in parallel therein. In other words, the electric proportional valve 24 is provided in the bypass flow channel 25, and the electromagnetic valve 26 is provided on the downstream side of the branch point with respect to the bypass flow channel 25 of the radiator tube 11.

In the second embodiment, as in the first embodiment, the temperature sensor 16 for detecting the temperature (T₁) of circulating liquid delivered from the constant temperature liquid circulating device 1 is provided in the vicinity of the outlet port 13a in the conduit 13, the temperature sensor 17 for detecting the temperature (T₂) of radiating water to be flowed in the radiator tube 11 is provided on the inlet port 11a side of the radiator tube 11, the pressure sensors 18a, 18b are provided at the inlet port 11a and the outlet port 11b of the radiator tube 11 for detecting the pressures (P₁, P₂) thereof, and the outputs therefrom are entered into the controller 19 together with the output from the flow amount sensor 15.

The pressure sensor 18a in the second embodiment is provided on the downstream side of the branch point with respect to the bypass flow channel 25 in the radiator tube 11. However, it is also possible to provide the same on the upstream side of the branch point. This is achieved by modifying a control system of the controller 19 in this case.

In order to control the temperature of circulating liquid in the water-cooled constant temperature liquid circulating device 1 according to the second embodiment, when controlling the flow amount of radiating water to be delivered to the heat exchange portion 11c, the optimal flow amount is delivered to the heat exchange portion 11c by controlling the flow amount of radiating water flowing toward the electromagnetic valve 25 by controlling the flow amount to be flowed in the bypass flow channel 25 by the electric proportional valve 24, and readjusting the resulted flow amount by the electromagnetic valve 26. When the electric proportional valve 24 is provided in the bypass flow channel 25, even when the electric proportional valve 24 is fully opened, a back pressure is generated, and hence the pressure is applied to the inlet port of the electromagnetic valve 26. However, the pressure cannot be further lowered. When the electric proportional valve is opened at a valve travel near the fully opened position, there is a range at which control of the flow amount is difficult. Therefore, the low flow limit value in the second embodiment, that is, the low flow limit value in which the flow amount of radiating water can be controlled by the electric proportional valve 24 means a limit value at which control of the low flow amount to be flowed to the electromagnetic valve 26 is difficult in a state in which the electric proportional valve 24 is fully opened or is at a position close thereto.

The mode of control of the flow amount of radiating water in the second embodiment will be described in detail. At least when the flow amount of radiating water required to be flowed to the radiator tube 11 is smaller than the low flow limit value, the pressure at the inlet port of the electromagnetic valve 26 is lowered by opening the electric proportional valve 24 and increasing the amount of radiating water to be flowed in the bypass flow channel 25 by the controller 19, and then the flow amount of radiating water is controlled to an optimal value by controlling the opening and closing duration of the electromagnetic valve 26.

On the other hand, when the flow amount of radiating water that is required to be flowed in the radiator tube 11 exceeds the high flow limit value that is high to an extent at which the water hammering phenomenon may occur when the electromagnetic valve is opened or closed, the controller 19 controls to fully open the electromagnetic valve 26 constantly, and the flow amount of radiating water flowing in the electromagnetic valve 26 to the optimal flow amount by controlling the valve travel of the electric proportional valve 24.

Accordingly, the required flow amount of radiating water is optimized, and the stability in temperature of circulating liquid is improved, whereby the lifetime of the electromagnetic valve can be improved.

Since other configurations and effects in the second embodiment shown in FIG. 2 are substantially the same as those of the water-cooled constant temperature liquid circulating device described in FIG. 1, the description thereof is omitted.

In any embodiments shown above, when the operation of the constant temperature liquid circulating device is stopped, or when the temperature of the constant temperature liquid in the tank 10 is within a predetermined range, and hence it is not necessary to radiate, it is also possible to control the electric proportional valve 24 and/or the electromagnetic valve 26 to be fully closed, so that waste of cooling water is avoided.

1. A water-cooled constant temperature liquid circulating device in which a heat exchange portion of the radiator tube, in which radiating water which is controlled in flow amount by a regulating means flows therein, is attached to a tank, a pump is provided in a conduit which allows the circulating liquid in the tank to circulate through the external device, and constant temperature circulating liquid in the tank is delivered into the piping in the external device which is connected to the inlet and outlet ports of the conduit by the pump comprising: the regulating means having
an electric proportional valve for controlling a flow amount of radiating water to be delivered to the heat exchange portion of the radiator tube at lease a low flow limit value at which a flow amount is suitably controlled for heat exchange of the circulating liquid in the heat exchange portion by the electric proportional valve, or a flow amount which is slightly larger; and
an electromagnetic valve for delivering the radiating water, which is controlled in flow amount by the electric proportional valve, to the heat exchange portion in an optimal flow amount regulated by controlling the opening-closing duration thereof.

2. The water-cooled constant temperature liquid circulating device according to claim 1, characterized in that a temperature sensor for detecting the temperature of the delivered circulating liquid is provided on an outlet port side of the conduit of the constant temperature liquid circulating device, a temperature sensor for detecting the temperature of radiating water is provided at an inlet port side of the radiator tube, pressure sensors for detecting the pressures are provided on the inlet port side and the outlet port side of the radiator tube, and the electric proportional valve and the electromagnetic valve are controlled by a controller, which receives outputs from these sensors together with outputs from the flow amount sensor in the conduit, so as to adjust the circulating liquid to a predetermined temperature.

3. The water-cooled constant temperature liquid circulating device according to claim 2, characterized in that the electric proportional valve and the electromagnetic valve in the radiator tube from the upstream side toward the downstream side are provided in series, and the flow amount of the radiating water controlled in flow amount by the electric proportional valve is readjusted by the electromagnetic valve and delivered to the heat exchange portion in the optimal flow amount.

4. The water-cooled constant temperature liquid circulating device according to claim 2, characterized in that a bypass flow channel is provided between the inlet port side and the outlet port side of the radiator tube, the electric proportional valve is provided in the bypass flow channel, and the electromagnetic valve is provided on the downstream side of the branch point of the radiator tube with respect to the bypass flow channel, the flow amount to be flowed into the bypass flow channel is controlled by the electric proportional valve, thereby readjusting the flow amount of radiating water flowing toward the electromagnetic valve by the electromagnetic valve, so that an optimal flow amount is delivered to the heat exchange portion.

5. The water-cooled constant temperature liquid circulating device according to claim 2, characterized in that a heat load of the external device is obtained on the basis of the difference between the temperature of circulating liquid detected by the temperature sensors and the temperature of radiating water and the flow amount of the circulating liquid detected by the flow amount sensor, the controller obtains a current cooling capability of the constant temperature liquid circulating device on the basis of the difference between the pressures detected by the pressure sensors provided on the inlet port side and the outlet port side of the radiator tube and the temperature detected by the temperature sensor provided on the inlet port side of the radiator tube, whereby the flow amount of the radiating water according to the cooling capability corresponding to the heat load is calculated and the electric proportional valve and the electromagnetic valve are controlled.

6. The water-cooled constant temperature liquid circulating device according to claim 3, characterized in that a heat load of the external device is obtained on the basis of the difference between the temperature of circulating liquid detected by the temperature sensors and the temperature of radiating water and the flow amount of the circulating liquid detected by the flow amount sensor, the controller obtains a current cooling capability of the constant temperature liquid circulating device on the basis of the difference between the pressures detected by the pressure sensors provided on the inlet port side and the outlet port side of the radiator tube and the temperature detected by the temperature sensor provided on the inlet port side of the radiator tube, whereby the flow amount of the radiating water according to the cooling capability corresponding to the heat load is calculated and the electric proportional valve and the electromagnetic valve are controlled.

7. The water-cooled constant temperature liquid circulating device according to claim 4, characterized in that a heat load of the external device is obtained on the basis of the difference between the temperature of circulating liquid detected by the temperature sensors and the temperature of radiating water and the flow amount of the circulating liquid detected by the flow amount sensor, the controller obtains a current cooling capability of the constant temperature liquid circulating device on the basis of the difference between the pressures detected by the pressure sensors provided on the inlet port side and the outlet port side of the radiator tube and the temperature detected by the temperature sensor provided on the inlet port side of the radiator tube, whereby the flow amount of the radiating water according to the cooling capability corresponding to the heat load is calculated and the electric proportional valve and the electromagnetic valve are controlled.

8. The method of controlling the temperature of circulating liquid with the water-cooled constant temperature liquid circulating device according to claim 3, comprising:
at least when the required flow amount of radiating water is smaller than the low flow limit value, controlling the electric proportional valve to flow radiating water by a low flow amount which does not underrun the limited value and regulating the flow amount of the radiating water to an optimal amount by controlling the opening and closing duration of the electromagnetic valve by a controller, and
when the required flow amount of radiating water exceeds a high flow limited amount which is high to an extent that may cause a water hammering phenomenon by the opening and closing of the electromagnetic valve, fully opening the electromagnetic valve constantly by the controller, and controlling the flow amount of the radiating water only by the electric proportional valve.

9. The method of controlling the temperature of circulating liquid in the water-cooled constant temperature liquid circulating device according to claim 4, comprising:
at least when the required flow amount of radiating water is smaller than the low flow limit value, lowering the pressure at an inlet port of the electromagnetic valve by opening the electric proportional valve to increase the amount of radiating water flowing in the bypass flow channel and controlling the flow amount of the radiating water to an optimal flow amount by controlling the opening and closing duration of the electromagnetic valve, and
when the amount of required flow amount of radiating water exceeds a high flow limit amount which is high to an extent that may cause a water hammering phenomenon by the opening and closing of the electromagnetic valve, fully opening the electromagnetic valve constantly by the controller, and controlling the flow amount of the radiating water flowing in the electromagnetic valve by controlling the valve travel of the electric proportional valve.
